(19) United States
(12) Patent Application Publication
(10) Pub. No.: US 2002/0114903 A1
(43) Pub. Date: Aug. 22, 2002

(54) Artificial tree leaf

(76) Inventor: Ying-Su Chung, Yun Lin Hsien (TW)

Correspondence Address: BROWDY AND NEIMARK, P.L.L.C., 624 NINTH STREET, NW, SUITE 300, WASHINGTON, DC, 20001-5303, US

(21) Appl. No.: 09/785,211

(22) Filed: Feb. 20, 2001

(51) Int. Cl. A01N 3/00

(52) U.S. Cl. 428/18

(57) ABSTRACT

An artificial tree leaf is made of a plastic material by molding. The leaf is similar in shape to a natural tree leaf and is provided with a grain resembling a vein of the natural tree leaf. The artificial tree leaf is resistant to deformation.

### FIELD OF THE INVENTION

The present invention relates generally to an ornamental article, and more particularly to an artificial leaf.

### BACKGROUND OF THE INVENTION

The artificial Christmas tree leaves are generally made of a plastic thin piece, which is cut into a number of slender strips resembling the coniferous leaves 1, as shown in FIG. 1. However, such conventional artificial Christmas tree leaves are in fact far from being similar to the natural tree leaves in terms of appearance, nature, color, and vein. As a matter of fact, the conventional artificial tree leaves are devoid of veins, as shown in FIG. 2. In addition, the conventional artificial tree leaves are prone to deformation.

### SUMMARY OF THE INVENTION

The primary objective of the present invention is to provide an artificial tree leaf free of the shortcomings of the conventional artificial tree leaf.

The artificial tree leaf of the present invention is made of a plastic thin piece under pressure at a predetermined temperature. The plastic thin piece is molded into a shape resembling the profile of a natural tree leaf. The artificial tree leaf of the present invention has a veinlike framework.

### BRIEF DESCRIPTION OF THE DRAWINGS

FIG. 1 shows a schematic view of a prior art Christmas tree leaves.

FIG. 2 shows a schematic view of one leaf of the prior art Christmas tree.

FIG. 3 shows a schematic view of artificial Christmas tree leaves of a first preferred embodiment of the present invention.

FIG. 4 shows a schematic view of one leaf of the first preferred embodiment of the present invention.

FIG. 5 shows a sectional view taken along the direction indicated by a line 5-5 as shown in FIG. 4.

FIG. 6 shows a schematic view of a second preferred embodiment of the present invention.

FIG. 7 shows a schematic view of a production process of the present invention.

FIG. 8 shows a schematic view of another production process of the present invention.

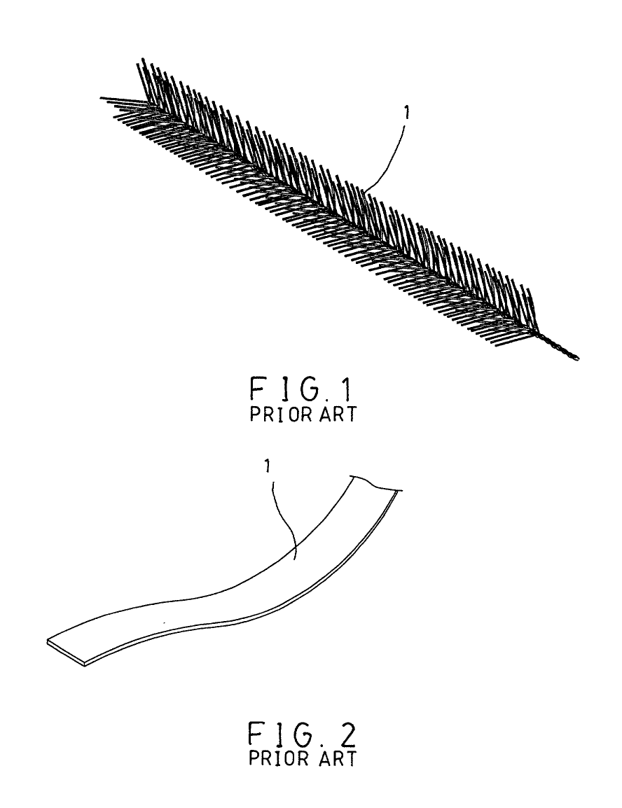

### DETAILED DESCRIPTION OF THE INVENTION

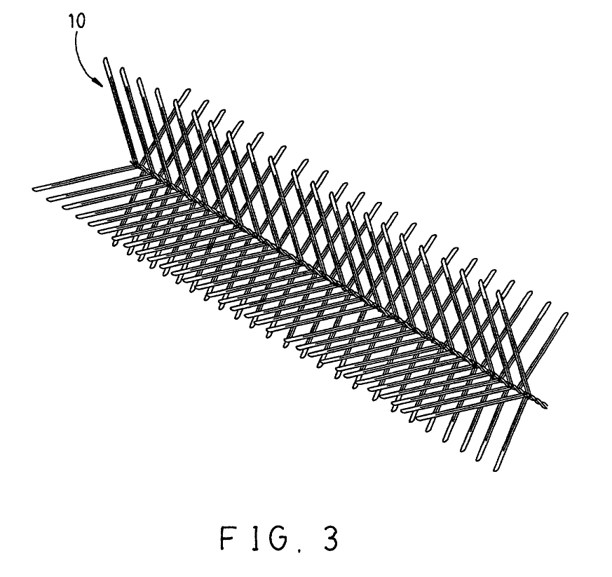

As shown in FIG. 3, artificial tree leaves 10 of the present invention are made of a plastic material, such as polyvinyl chloride, polypropylene, etc. The leaves 10 are similar in profile to the natural coniferous leaves.

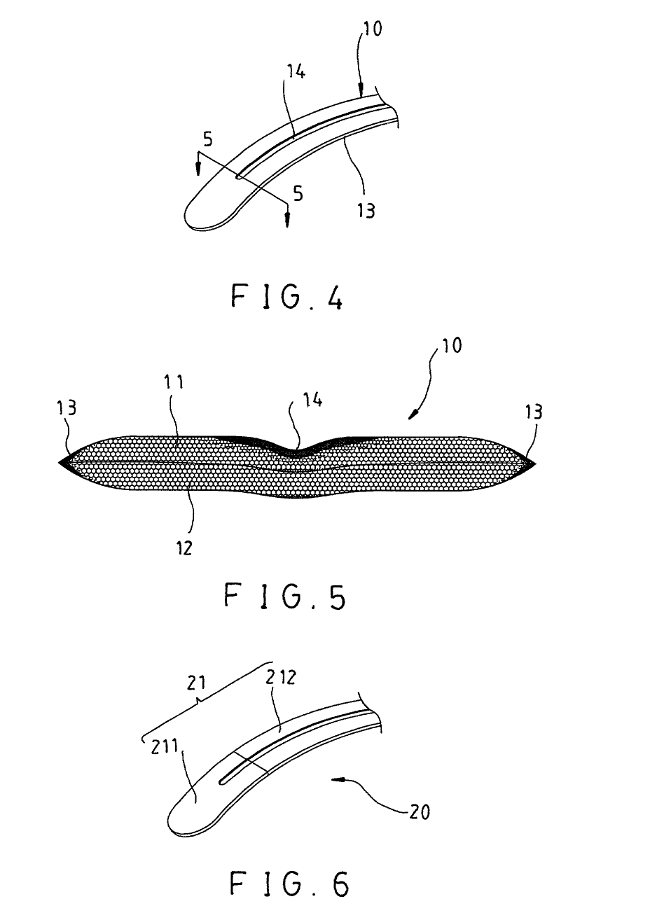

As shown in FIGS. 4 and 5, one single leaf 10 of the present invention is formed of an upper layer 11, a lower layer 12, two longitudinal ends 13, and a vein 14.

The upper layer 11 and the lower layer 12 are joined together under pressure at a predetermined temperature. The upper layer 11 has a color resembling the green color of the natural tree leaves. The lower layer 12 has a lighter green color to reflect the fact that the underside of the natural tree leaves is exposed to sunlight to a lesser extent.

The longitudinal ends 13 of the present invention are so molded that they look like the ends of the natural coniferous leaves. The longitudinal ends 13 also serve to hold the upper layer 11 and the lower layer 12 securely together so as to prevent deformation of the leaf 10 of the present invention.

In the molding process of the present invention, the upper layer 11 is provided with a grain 14 resembling a vein of the natural tree leaf. In light of the solid texture of the grain 14, the leaf 10 of the present invention is resistant to deformation.

As shown in FIG. 6, an artificial tree leaf 20 of another preferred embodiment of the present invention comprises an upper layer 21 which is formed of two plastic skins 211 and 212 different in color from each other. The skin 211 is brown to indicate the withering of the leaf. The leaf 20 of the present invention is made of only one plastic skin.

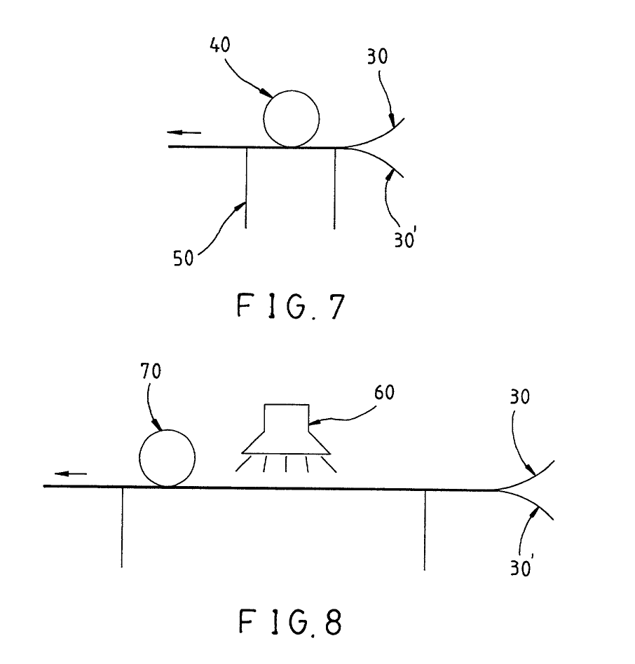

As shown in FIG. 7, a production process of the present invention comprises a molding tool 40 and an ultrasonic shaker 50. Two plastic skins 30 and 30′ are stacked together between the molding tool 40 and the ultrasonic shaker 50. The process is provided with heat by the ultrasonic shaker 50. As shown in FIG. 8, the two plastic skins 30 and 30′ are preheated by a heater 60 before the plastic skins 30 and 30′ are transferred to a molding tool 70. Upon completion of the molding process, the product is cooled by air or a cooling device.

What is claimed is:

1. An artificial tree leaf made of a plastic material under pressure at a predetermined temperature, said leaf being similar in shape to a natural tree leaf and having a grain resembling a vein of the natural tree leaf, thereby making said leaf resistant to deformation.

2. The artificial tree leaf as defined in claim 1, wherein said leaf is formed of an upper layer and a lower layer joined intimately with said upper layer.

3. The artificial tree leaf as defined in claim 2, wherein said upper layer is made of two plastic skins different in color.

4. The artificial tree leaf as defined in claim 1, wherein said plastic material is a polymer, such as polyvinyl chloride, polypropylene, etc.
